(19) United States
(12) Patent Application Publication
(10) Pub. No.: US 2013/0127804 A1
(43) Pub. Date: May 23, 2013

(54) DATA DRIVING APPARATUS, DISPLAY DEVICE INCLUDING THE SAME, AND DRIVING METHOD THEREOF

(71) Applicants: Won Tae KIM, Cheongju-si (KR); Sun Kyu Son, Suwon-si (KR); Ok-Kwon Shin, Asan-si (KR)

(72) Inventors: Won Tae KIM, Cheongju-si (KR); Sun Kyu Son, Suwon-si (KR); Ok-Kwon Shin, Asan-si (KR)

(21) Appl. No.: 13/443,679

(22) Filed: Apr. 10, 2012

(30) Foreign Application Priority Data
Nov. 17, 2011 (KR) 10-2011-0120389

(51) Int. Cl. G09G 5/00

(52) U.S. Cl. 345/211

(57) ABSTRACT

The data driving apparatus includes a gamma data storage unit storing p-bit gamma data, a conversion data storage unit storing q-bit gamma data corresponding to the p-bit gamma data, a gamma data conversion unit converting the p-bit gamma data into the q-bit gamma data based on the conversion data storage unit, and a gamma voltage generator generating gamma voltage from the q-bit gamma data, in which the conversion data storage unit is refreshed in a vertical blank period.

### CROSS-REFERENCE TO RELATED APPLICATION

This application claims priority to Korean Patent Application No. 10-2011-0120389 filed in the Korean Intellectual Property Office on Nov. 17, 2011, the entire contents of which are incorporated by reference herein.

### TECHNICAL FIELD

Embodiments of the present invention relate to a data driving apparatus, a display device including the data driving apparatus, and a driving method of the display device, and more particularly to a data driving apparatus that can prevent an error from occurring due to static electricity when displaying images, a display device including the data driving apparatus, and a driving method of the display device.

### DISCUSSION OF THE RELATED ART

A display device is used for a computer monitor, a television, a mobile phone and other various electronic devices. Examples of a display device include a cathode ray tube display device, a liquid crystal display, and a plasma display device.

A liquid crystal display, which is a flat panel display, includes two display panels having field generating electrodes such as pixel electrodes and a common electrode, with a liquid crystal layer interposed between the two display panels. The liquid crystal display generates an electric field in the liquid crystal layer by applying voltage to the field generating electrodes and determines the orientation of liquid crystal molecules in the liquid crystal layer by the generated electric field, thus controlling polarization of incident light to display images.

The display device such as the liquid crystal display includes a display panel and a signal controller. The signal controller drives the display device by transmitting image data and control signals for driving the display panel to the display panel.

Static electricity produced in the display device is transferred to the driving circuit through a signal line and may thus damage the driving circuit. As a result, pixels connected to the damaged driving circuit do not operate properly.

### SUMMARY

Embodiments of the present invention provide a data driving apparatus that can prevent damage to a driving circuit due to static electricity which may cause an error when displaying images, a display device including the data driving apparatus, and a driving method of the display device.

An exemplary embodiment of the present invention provides a data driving apparatus, including a gamma data storage unit storing p-bit gamma data, a conversion data storage unit storing q-bit gamma data corresponding to the p-bit gamma data, a gamma data conversion unit converting the p-bit gamma data into the q-bit gamma data based on the conversion data storage unit, and a gamma voltage generator generating gamma voltage from the q-bit gamma data, in which the conversion data storage unit is refreshed during a vertical blank period.

The conversion data storage unit includes a lookup table.

The conversion data storage unit is refreshed by receiving the q-bit gamma data corresponding to the p-bit gamma data from the outside for one or two horizontal periods of the vertical blank period for each frame.

The p-bit gamma data and the gamma voltage have a nonlinear relationship and the q-bit gamma data and the gamma voltage have a linear relationship.

According to an embodiment, p is 8, and q is 11.

An exemplary embodiment of the present invention provides a display device, including a display panel including a plurality of pixels, a signal controller controlling signals for driving the display panel, and a data driver receiving reference gamma data and image data from the signal controller and outputting data voltage to the display panel, in which the data driver includes a gamma data storage unit storing p-bit gamma data obtained by dividing the reference gamma data, a conversion data storage unit storing q-bit gamma data corresponding to the p-bit gamma data, a gamma data conversion unit converting the p-bit gamma data into the q-bit gamma data based on the conversion data storage unit, and a gamma voltage generator generating a gamma voltage from the q-bit gamma data, and the conversion data storage unit is refreshed during a vertical blank period.

An interface between the signal controller and the data driver includes an advanced intra panel interface (AiPi) or a universal service interface (USI).

The display device further includes a storage unit storing the q-bit gamma data corresponding to the p-bit gamma data.

The storage unit includes an electrically erasable programmable read-only memory (EEPROM).

The signal controller receives the q-bit gamma data corresponding to the p-bit gamma data from the storage unit for one horizontal period or two horizontal periods of the vertical blank period for each frame to refresh the conversion data storage unit.

The storage unit communicates with the signal controller via an inter integrated circuit (I²C).

The conversion data storage unit includes a lookup table.

The p-bit gamma data and the gamma voltage have a nonlinear relationship and the q-bit gamma data and the gamma voltage have a linear relationship.

According to an embodiment, p is 8, and q is 11.

An exemplary embodiment of the present invention provides a driving method of a display device, including transmitting q-bit gamma data corresponding to p-bit gamma data to a conversion data storage unit, converting the p-bit gamma data into the q-bit gamma data, generating gamma voltage from the q-bit gamma data, transmitting image data to a data driver, and generating a data voltage corresponding to the image data based on the gamma voltage and supplying the data voltage to a display panel, in which the conversion data storage unit is refreshed during a vertical blank period.

The conversion data storage unit includes a lookup table.

The conversion data storage unit is refreshed by receiving the q-bit gamma data corresponding to the p-bit gamma data from the outside for one or two horizontal periods of the vertical blank period for each frame.

The p-bit gamma data and the gamma voltage have a nonlinear relationship and the q-bit gamma data and the gamma voltage have a linear relationship.

According to an embodiment, p is 8, and q is 11.

The transmission of the q-bit gamma data corresponding to the p-bit gamma data is performed via an advanced intra panel interface (AiPi) or a universal service interface (USI).

The data driving apparatus, the display device including the data driving apparatus, and the driving method of the display device according to an exemplary embodiment of the present invention have the following effects.

According to an exemplary embodiment of the present invention, the data driving apparatus, the display device including the data driving apparatus, and the driving method of the display device refresh the conversion data storage unit for each frame in the vertical blank period where no image data is transmitted, such that even though a memory inside a driving circuit is damaged due to static electricity, the memory is recovered to prevent an error from being recognized when displaying a screen.

Since the advanced intra panel interface (AiPi) or the universal service interface (USI) is used between the signal controller and the data driver, it is possible to transmit the q-bit gamma data corresponding to the p-bit gamma data within one horizontal period or two horizontal periods.

Since I²C communication is not used between the signal controller and the data driver, it is possible to reduce the number of signal lines of a flexible flat cable (FFC), a contact pin, and a printed circuit board (PCB) and reduce electromagnetic interference (EMI).

### BRIEF DESCRIPTION OF THE DRAWINGS

FIG. 1 is a block diagram showing a display device according to an exemplary embodiment of the present invention.

FIG. 2 is a block diagram showing a signal controller and a data driver of a display device according to an exemplary embodiment of the present invention.

FIG. 3 is a block diagram showing a data driver of a display device according to an exemplary embodiment of the present invention.

FIGS. 4 and 5 are timing diagrams showing signals which are transmitted from a signal controller to a data driver of a display device according to an exemplary embodiment of the present invention.

### DETAILED DESCRIPTION OF THE EMBODIMENTS

The embodiments of the present invention will be described with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like or similar elements throughout the specification and the drawings. It will be understood that when an element such as a layer, film, region, or substrate is referred to as being “on” another element, it can be directly on the other element or intervening elements may also be present.

As used herein, the singular forms, “a,” “an” and “the” are intended to include the plural forms as well, unless the context clearly indicates otherwise.

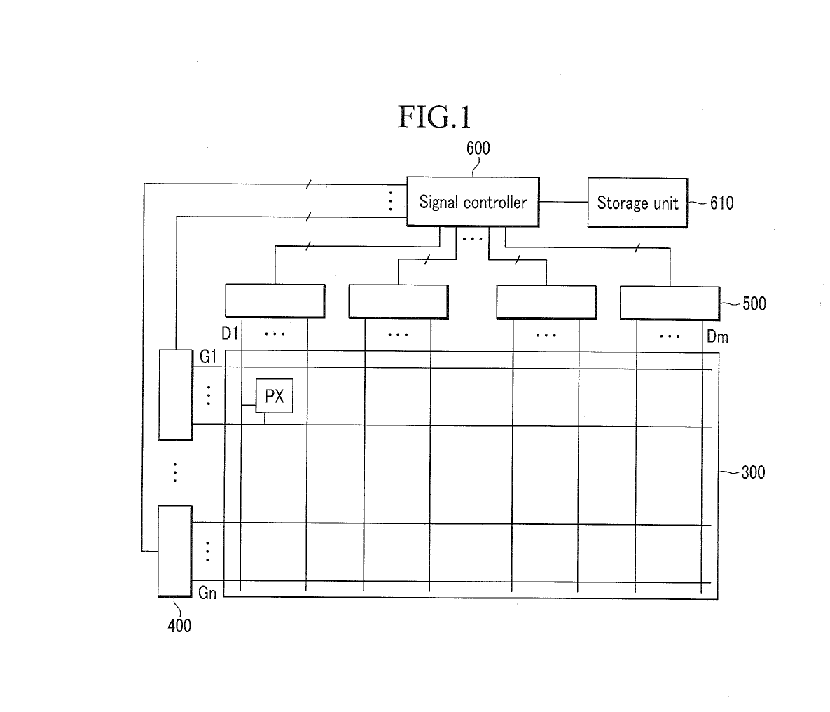

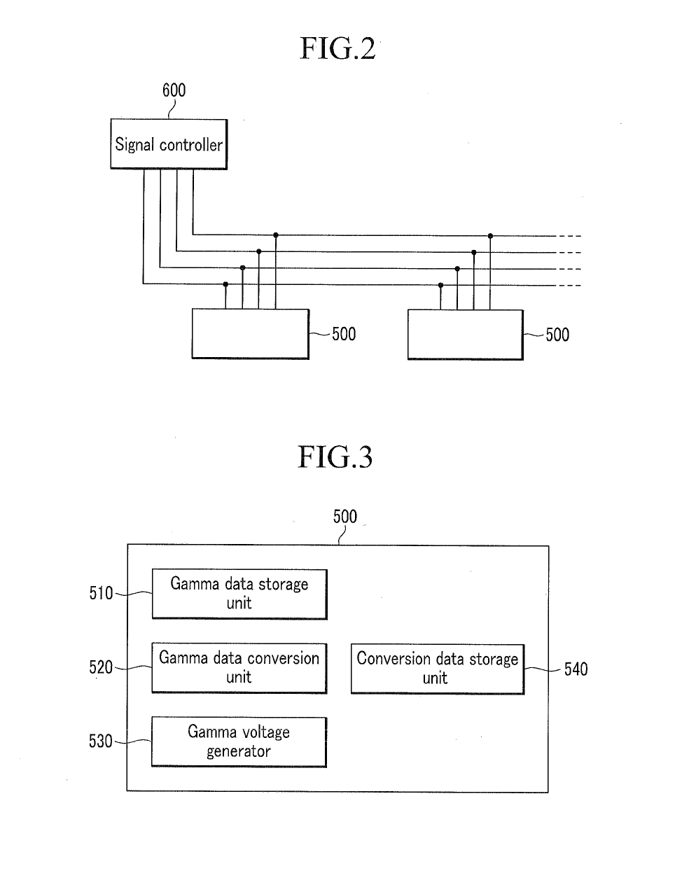

FIG. 1 is a block diagram showing a display device according to an exemplary embodiment of the present invention, and FIG. 2 is a block diagram showing a signal controller and a data driver of a display device according to an exemplary embodiment of the present invention.

A display device according to an exemplary embodiment of the present invention includes a display panel 300 including a plurality of pixels, a signal controller 600 controlling signals for driving the display panel 300, and a gate driver 400 and a data driver 500 applying signals for driving the display panel 300.

The display panel 300 includes a plurality of gate lines G₁-Gₙ and a plurality of data lines D₁-Dₘ. The plurality of gate lines G₁-Gₙ extend in a horizontal direction, and the plurality of data lines D₁-Dₘ extend in a vertical direction and cross the plurality of gate lines G₁-Gₙ.

The display panel 300 includes pixels PX connected to the gate lines G₁-Gₙ and the data lines D₁-Dₘ. A pixel PX includes a switching element which is connected to a gate line G₁-Gₙ and a data line D₁-Dₘ. A control terminal of the switching element is connected to the gate line G₁-Gₙ, an input terminal of the switching element is connected to the data line D₁-Dₘ, and an output terminal of the switching element is connected to a liquid crystal capacitor and a storage capacitor.

The display panel 300 includes a first substrate on which the gate lines G₁-Gₙ, the data lines D₁-Dₘ, the pixels PX, the switching elements, and the like are formed, a second substrate opposite to the first substrate, and a liquid crystal layer interposed between the first substrate and the second substrate.

Although the display panel 300 is described as a liquid crystal panel, the embodiments of the present invention are not limited thereto and according to an embodiment various display panels, such as an organic light emitting panel, an electrophoretic display panel, and a plasma display panel, may be used.

The signal controller 600 controls the gate driver 400 and the data driver 500. The signal controller 600 receives image data and control signals for controlling a display of the image data from an external graphic controller (not shown). The image data includes luminance information on each of the pixels PX and luminance has a predetermined number of, for example, 1024=2¹⁰, 256=2⁸ or 64=2⁶ grays. Examples of the control signals include a vertical synchronization signal Vsync, a horizontal synchronization signal Hsync, a main clock signal MCLK, and a data enable signal DE.

The signal controller 600 processes the image data in accordance with an operating condition of the display panel 300 based on the control signals, generates a gate control signal CONT1 and a data control signal CONT2, and then transmits the gate control signal CONT1 to the gate driver 400 and the data control signal CONT2 and the processed image data to the data driver 500.

The gate driver 400 is connected to the gate lines G₁-Gₙ of the display panel 300 and applies gate signals including gate-on voltages Von and gate-off voltages Voff to the gate lines G₁-Gₙ.

The data driver 500 is connected to the data lines D₁-Dₘ of the display panel 300 and applies voltages respectively corresponding to gray levels of the image data received from the signal controller 600 as data voltages to the data lines D₁-Dₘ. The data driver 500 determines a gamma voltage corresponding to a gray level of corresponding image data as a data voltage based on gamma data.

According to an embodiment, each of the drivers 400, 500, and 600 is mounted on the display panel 300 in the form of at least one IC chip, mounted on a flexible printed circuit film (not shown) attached to display panel 300 in the form of a tape carrier package (TCP), or mounted on a separate printed circuit board (PCB) (not shown). Alternatively, the drivers 400, 500, and 600 are integrated on the display panel 300 with the signal lines G₁-Gₙ and D₁-Dₘ and the switching elements. According to an embodiment, the drivers 400, 500, and 600 are integrated into a single chip so that at least one of the drivers or at least one circuit element included in the drivers is positioned outside the single chip.

Referring to FIG. 2, the signal controller 600 and a plurality of data drivers 500 are connected to each other through four signal lines. Each of the plurality of data drivers 500 is connected to the four signal lines and receive signals from the signal controller 600. As an interface between the signal controller 600 and the data drivers 500, a high speed interface is used and increases transmission speed of data. For example, the high speed interface includes an advanced intra panel interface (AiPi) or a universal service interface (USI). The signal controller 600 transmits image data and reference gamma data to the data driver 500 via the high speed interface. The image data has values representing gray levels for pixels. The reference gamma data has values representing some gray levels between a black gray level and a white gray level. For example, the reference gamma data includes four values such as gray level 0, gray level 255, and two other gray levels between gray level 0 and gray level 255.

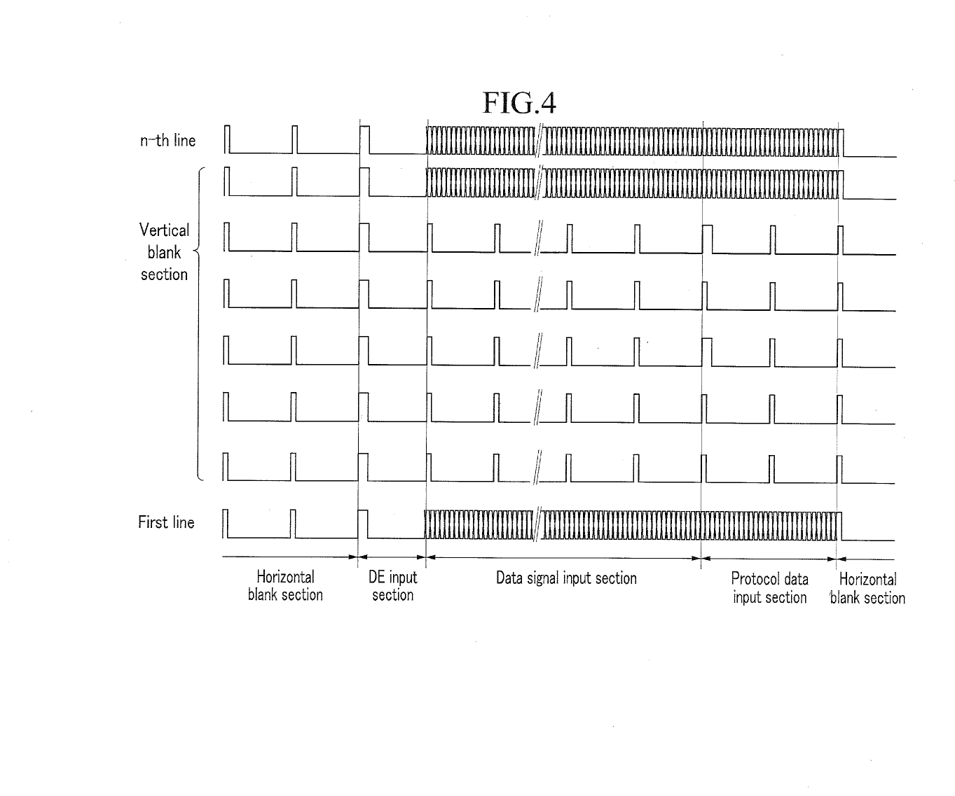

Hereinafter, the data driver 500 is described in more detail with reference to FIG. 3.

FIG. 3 is a block diagram showing a data driver of a display device according to an exemplary embodiment of the present invention.

The data driver 500 includes a gamma data storage unit 510 storing p-bit gamma data obtained by dividing reference gamma data, a conversion data storage unit 540 storing q-bit gamma data corresponding to the p-bit gamma data, a gamma data conversion unit 520 converting the p-bit gamma data into the q-bit gamma data based on the conversion data storage unit 540, and a gamma voltage generator 530 generating gamma voltages from the q-bit gamma data.

The gamma data storage unit 510 divides the reference gamma data into the p-bit gamma data which represent a plurality of gray levels and stores the p-bit gamma data. For example, when p is 8, the gamma data includes 2⁸ (=256) gray levels.

When some gray levels of the p-bit gamma data are represented as the q-bit gamma data, the conversion data storage unit 540 stores data about what gray levels the q-bit gamma data have. For example, according to an embodiment, the conversion data storage unit 540 includes information on correspondence between gray levels of the p-bit gamma data and gray levels of the q-bit gamma data. For example, according to an embodiment, q has a larger value than p. For example, when q is 11, the q-bit gamma data include 2¹¹(=2048) gray levels.

The 8-bit gamma data include 256 gray levels between a black gray level and a white gray level, and the 11-bit gamma data includes 2048 gray levels between a black gray level and a white gray level.

Since human eyes are more sensitive to a luminance change sensed in a dark environment than in a bright environment, correction is needed so that the 8-bit gamma data are in direct proportion to a cerebral sense. The 8-bit gamma data and the gamma voltages have a nonlinear relationship with each other.

According to an exemplary embodiment of the present invention, the use of 11-bit gamma data makes the gamma data in direct proportion to the cerebral sense without the correction. The 11-bit gamma data includes 2048 gray levels, but uses 256 gray levels corresponding to the 8-bit gamma data. The 11-bit gamma data and the gamma voltages have a linear relationship with each other. The conversion data storage unit 540 may store, in a lookup table form, gray levels of the 11-bit gamma data which correspond to the 256 gray levels of the 8-bit gamma data.

For example, as shown in Table 1, gray levels of the 11-bit gamma data respectively correspond to gray level 0 to gray level 255 of the 8-bit gamma data.

TABLE 1

| 8-bit gamma data | 11-bit gamma data |
|---|---|
| 00000000 | 00000000000 |
| 00000001 | 00000000011 |
| 01111000 | 01111101010 |
| 11111110 | 11111110010 |
| 11111111 | 11111111110 |

Table 1 is merely an example and according to an embodiment has other values. According to an embodiment, the lookup table changes as p and q vary.

The values stored in the conversion data storage unit 540 may be damaged due to an external factor, for example, static electricity. The values are repeatedly supplied at a predetermined period so that the conversion data storage unit 540 is refreshed. The refreshing of the conversion data storage unit 540 is described below in more detail.

The gamma data conversion unit 520 converts the p-bit gamma data into the q-bit gamma data based on the conversion data storage unit 540. For example, according to an embodiment, the gamma data conversation unit 520 refers to the lookup table for the conversion. For example, when the 8-bit gamma data is 01111000, 01111101010 is generated as the 11-bit gamma data based on the lookup table shown in Table 1.

The gamma voltage generator 530 generates gamma voltages that respectively correspond to the gray levels of the q-bit gamma data converted by the gamma data conversion unit 520.

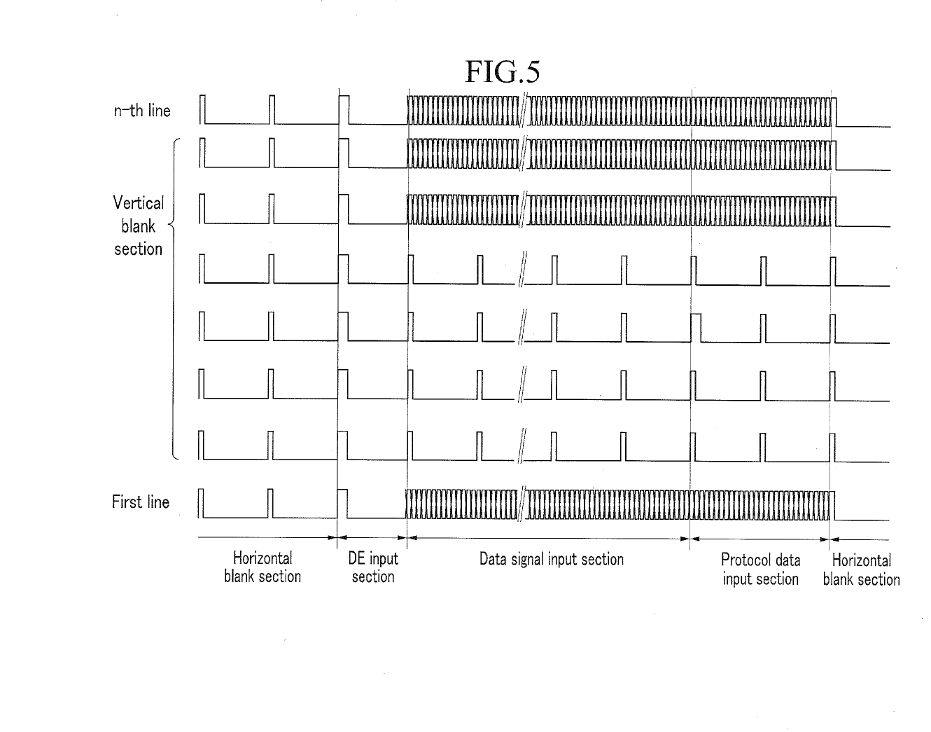

Hereinafter, the refreshing of the conversion data storage unit 540 is described with reference to FIGS. 4 and 5.

FIGS. 4 and 5 are timing diagrams illustrating signals transmitted from a signal controller to a data driver of a display device according to an exemplary embodiment of the present invention.

The signal controller 600 transmits a frame of image data over a plurality of separate sections. According to an embodiment, each frame of image data is transmitted on a per-horizontal line basis. According to an embodiment, before the image data is transmitted, a data enable signal DE is inputted. For example, a data enable signal DE is transmitted and then image data for a corresponding horizontal line is transmitted. A period of time taken to transmit image data for one horizontal line is referred to as “one horizontal period”. After transmitting the image data for one horizontal line, protocol data is transmitted. Before transmitting image data for a next horizontal line, a blank section is provided, which is referred to as a “horizontal blank period”.

After transmitting all the image data for one frame, a blank section is provided before transmitting image data for a next frame and this blank section is referred to as a “vertical blank period”. As shown in FIG. 4, after transmitting image data for an n-th line, a vertical blank period is provided before image data for a first line of a next frame is transmitted.

In the vertical blank period, a clock signal is input. In an exemplary embodiment of the present invention, the conversion data storage unit 540 receives data for refreshing the conversion data storage unit 540 during the vertical blank period. For example, in the vertical blank period, the signal controller 600 transmits the q-bit gamma data corresponding to the p-bit gamma data to the data driver 500.

As a consequence, even though the conversion data storage unit 540 is damaged due to static electricity so that a distorted frame is displayed, the conversion data storage unit 540 is refreshed during the vertical blank period between the distorted frame and a next frame, so that the next frame can be restored. Human eyes can recognize about 20 frames per second. In the case that the display device is driven at 60 Hz, when an image frame is damaged, and a next image frame is restored to be normal, human eyes cannot recognize the damaged image frame.

As an interface between the signal controller 600 and the data driver 500, a high speed interface, such as an advanced intra panel interface (AiPi) or a universal service interface (USI), is used, that can transmit a large amount of data in a short time. According to an embodiment, it takes a time corresponding to one horizontal period or two horizontal periods to transmit the q-bit gamma data corresponding to the p-bit gamma data.

Referring to FIG. 4, after transmitting image data for an n-th line, the q-bit gamma data corresponding to the p-bit gamma data are transmitted during one horizontal period after the vertical blank period starts.

Referring to FIG. 5, after transmitting image data for the n-th line, the q-bit gamma data corresponding to the p-bit gamma data are transmitted during two horizontal periods after the vertical blank period starts.

According to an embodiment, a data size required for transmission changes according to settings of the p bits and the q bits, and as a result, time of less than one horizontal period or more than two horizontal periods may be required.

Since the q-bit gamma data corresponding to the p-bit gamma data can be transmitted for the time corresponding to one horizontal period or two horizontal periods, the conversion data storage unit 540 can be refreshed for each frame. For example, the signal controller 600 can transmit the q-bit gamma data corresponding to the p-bit gamma data to the data driver 500 for each frame via an interface that can transmit data in a short time.

According to an embodiment, the display device further includes a storage unit 610. The storage unit 610 stores q-bit gamma data corresponding to p-bit gamma data. According to an embodiment, the storage unit 610 includes an electrically erasable programmable read-only memory (EEPROM). The signal controller 600 receives the q-bit gamma data corresponding to p-bit gamma data from the storage unit 610 and transmits the q-bit gamma data to the conversion data storage unit 540 of the data driver 500. The signal controller 600 and the storage unit 610 communicate with each other in an inter integrated circuit (I²C) manner.

A driving method of a display device according to an exemplary embodiment of the present invention is described below with reference to FIGS. 1 to 5.

The signal controller 600 transmits a frame of image data for each of a first line to an n-th line to the data driver 500.

After transmitting all the frame of image data, the signal controller 600 transmits the q-bit gamma data corresponding to the p-bit gamma data to the conversion data storage unit 540 of the data driver 500 during the vertical blank period, so that the conversion data storage unit 540 is refreshed.

The signal controller 600 transmits data to the conversion data storage unit 540 via a high speed interface, such as an advanced intra panel interface (AiPi) and a universal service interface (USI). As a consequence, a large amount of data can be transmitted in a short time. For example, it takes a time corresponding to one horizontal period or two horizontal periods to transmit the q-bit gamma data corresponding to the p-bit gamma data. The conversion data storage unit 540 can be refreshed for each frame.

The conversion data storage unit 540 includes a lookup table storing the q-bit gamma data corresponding to the p-bit gamma data. For example, the p bits are 8 bits, the n bits are 11 bits, and gray levels of 11-bit gamma data respectively corresponding to 256 gray levels of 8-bit gamma data are represented in the lookup table. The 8-bit gamma data and the gamma voltages may have a nonlinear relationship with each other, and the 11-bit gamma data and the gamma voltages may have a linear relationship with each other.

The gamma data conversion unit 520 of the data driver 500 converts the p-bit gamma data stored in the gamma data storage unit 510 into the q-bit gamma data based on the conversion data storage unit 540. For example, the gamma data conversion unit 520 refers to the lookup table included in the conversion data storage unit 540 for the conversion from the p-bit gamma data into the q-bit gamma data.

The gamma voltage generator 530 generates gamma voltage from the converted q-bit gamma data.

After the vertical blank period, the signal controller 600 transmits a next frame of image data for each of a first line to an n-th line to the data driver 500.

Thereafter, voltages of gray levels of the frame of image data are generated as data voltages based on the gamma voltages and supplied to the data lines D₁-Dₘ of the display panel 300.

While the embodiments of the invention have been described in connection with the accompanying drawings, it is to be understood that the embodiments of the invention are not limited thereto and are intended to cover various modifications and equivalent arrangements included within the spirit and scope of the appended claims.

What is claimed is:

1. A data driving apparatus comprising:
a gamma data storage unit configured to store p-bit gamma data;
a conversion data storage unit configured to store q-bit gamma data corresponding to the p-bit gamma data;
a gamma data conversion unit configured to convert the p-bit gamma data into the q-bit gamma data based on data included in the conversion data storage unit; and
a gamma voltage generator configured to generate a gamma voltage from the q-bit gamma data,
wherein the conversion data storage unit is configured to be refreshed during a vertical blank period.

2. The data driving apparatus of claim 1, wherein the conversion data storage unit includes a lookup table.

3. The data driving apparatus of claim 1, wherein the conversion data storage unit is configured to be refreshed by receiving the q-bit gamma data during one or two horizontal periods of the vertical blank period for each frame.

4. The data driving apparatus of claim 1, wherein the p-bit gamma data and the gamma voltage have a nonlinear relationship, and the q-bit gamma data and the gamma voltage have a linear relationship.

5. The data driving apparatus of claim 1, wherein p is 8, and q is 11.

6. A display device comprising:
a display panel including a plurality of pixels;
a signal controller configured to control signals for driving the display panel; and
a data driver configured to receive reference gamma data and image data from the signal controller and to output a data voltage to the display panel,
wherein the data driver includes,
a gamma data storage unit configured to store p-bit gamma data obtained by dividing the reference gamma data;
a conversion data storage unit configured to store q-bit gamma data corresponding to the p-bit gamma data;
a gamma data conversion unit configured to convert the p-bit gamma data into the q-bit gamma data based on data included in the conversion data storage unit; and
a gamma voltage generator configured to generate a gamma voltage from the q-bit gamma data, wherein the conversion data storage unit is configured to be refreshed during a vertical blank period.

7. The display device of claim 6, wherein an interface between the signal controller and the data driver includes an advanced intra panel interface (AiPi) or a universal service interface (USI).

8. The display device of claim 6, further comprising:
a storage unit configured to store the q-bit gamma data.

9. The display device of claim 7, wherein the signal controller is configured to receive the q-bit gamma data from the storage unit for one or two horizontal periods of the vertical blank period for each frame.

10. The display device of claim 8, wherein the storage unit is configured to communicate with the signal controller via an inter integrated circuit (I²C).

11. The display device of claim 6, wherein the conversion data storage unit includes a lookup table.

12. The display device of claim 6, wherein the p-bit gamma data and the gamma voltage have a nonlinear relationship, and the q-bit gamma data and the gamma voltage have a linear relationship.

13. The display device of claim 6, wherein p is 8, and q is 11.

14. A driving method of a display device, comprising:
transmitting q-bit gamma data corresponding to p-bit gamma data to a conversion data storage unit;
converting the p-bit gamma data into the q-bit gamma data;
generating a gamma voltage from the q-bit gamma data;
transmitting image data to a data driver; and
generating a data voltage corresponding to the image data based on the gamma voltage and supplying the data voltage to a display panel,
wherein the conversion data storage unit is refreshed during a vertical blank period.

15. The driving method of claim 14, wherein the conversion data storage unit includes a lookup table.

16. The driving method of claim 14, wherein the conversion data storage unit is configured to be refreshed by receiving the q-bit gamma data during one or two horizontal periods of the vertical blank period for each frame.

17. The driving method of claim 14, wherein the p-bit gamma data and the gamma voltage have a nonlinear relationship, and the q-bit gamma data and the gamma voltage have a linear relationship.

18. The driving method of claim 14, wherein p is 8, and q is 11.

19. The driving method of claim 14, wherein the transmission of the q-bit gamma data is performed via an advanced intra panel interface (AiPi) or a universal service interface (USI).

20. A display device comprising:
a display panel;
a data driver configured to transmit data voltages to the display panel, wherein the data driver includes a lookup table; and
a signal controller configured to transmit gamma data and image data to the data driver, wherein the lookup table is refreshed after a first frame of image data is transmitted to the data driver and before a second frame of image data is transmitted to the data driver.
